(19) United States
(12) Patent Application Publication
(10) Pub. No.: US 2013/0017504 A1
(43) Pub. Date: Jan. 17, 2013

(54) FURNACE

(71) Applicants: Won Hee YOO, Gyeonggi-do (KR); Yun Hwi PARK, Gyeonggi-do (KR); Byeung Gyu CHANG, Gyeonggi-do (KR)

(72) Inventors: Won Hee YOO, Gyeonggi-do (KR); Yun Hwi PARK, Gyeonggi-do (KR); Byeung Gyu CHANG, Gyeonggi-do (KR)

(73) Assignee: Samsung Electro-Mechanics Co., Ltd., Suwon (KR)

(21) Appl. No.: 13/473,215

(22) Filed: May 16, 2012

(30) Foreign Application Priority Data
Jul. 11, 2011 (KR) 10-2011-0068497

(51) Int. Cl. F27D 19/00; F27D 21/04

(52) U.S. Cl. 432/49

(57) ABSTRACT

Disclosed herein is a furnace, including: a body having a space formed therein; a plurality of thermocouples disposed in the body and vertically movably coupled with the body; a plurality of heating elements dispose in the body; and a control unit that receives temperature data from the thermocouples to control temperature of the heating elements, whereby the furnace can measure and control the temperature for each portion of the internal space to form uniform temperature distribution, in particular, make temperature distribution of the heat applied to the fired matter uniform to obtain high-quality fired matter.

### CROSS REFERENCE(S) TO RELATED APPLICATIONS

This application claims the benefit under 35 U.S.C. Section 119 of Korean Patent Application Serial No. 10-2011-0068497, entitled “Furnace” filed on Jul. 11, 2011, which is hereby incorporated by reference in its entirety into this application.

### BACKGROUND OF THE INVENTION

1. Technical Field

The present invention relates to a furnace, and more particularly, to a furnace measuring an internal temperature using a thermocouple.

2. Description of the Related Art

A furnace is mainly used for a process for heating and firing a ceramic substrate. An internal temperature is measured using a thermocouple and a heating element in the furnace is controlled based on temperature measured through the thermocouple.

In a general furnace, the internal temperature is measured using one thermocouple, but when the furnace is large or precise temperature control is required, the internal temperature is measured using about two and three thermocouples.

The furnace generates a difference in temperature according to the internal position. As a result, it is impossible to measure temperature according to the internal position by using two to three thermocouples. Since the thermocouple is installed to be close to the heating element, it is difficult to measure temperature of heat substantially transferred to a fired matter disposed therein.

In particular, when firing a low temperature co-fired ceramic (LTCC) substrate, a temperature distribution in the furnace is non-uniform, such that the substrate is heated non-uniformly, thereby applying a local thermal impact to the substrate. The thermal impact applied to the substrate generates cracks and fine ruptures and delaminates a laminated ceramic green sheet, thereby causing defects of the substrate.

In order to solve the above problems, the temperature of the furnace may be measured by a method of using a temperature measurement standard sample or be measured by a method of inserting a wire type of a thermocouple into an exhaust hole or into a chin of the door from the outside. These methods cannot measure the temperature that is substantially transferred to the fired matter and are hard to detect temperature for each position in the furnace.

### SUMMARY OF THE INVENTION

An object of the present invention is to provide a furnace capable of forming a uniform temperature gradient and measuring an actual temperature of a fired matter by accurately measuring a temperature distribution in a furnace.

According to an exemplary embodiment of the present invention, there is provided a furnace, including: a body having a space formed therein; a plurality of thermocouples disposed in the body and vertically movably coupled with the body; a plurality of heating elements disposed in the body; and a control unit receiving temperature data from the thermocouples to control temperature of the heating elements.

The thermocouple may be screwed to the body so as to vertically move by rotation.

The thermocouple and the body may be fixed to each other through a plurality of convex parts and a plurality of concave parts that are vertically formed.

The furnace may further include a vertical rack gear fixed to the thermocouple and a pinion gear corresponding to the rack gear, wherein the thermocouple vertically moves by the rotation of the pinion gear.

The body may be a box type having a rectangular parallelepiped shape.

### BRIEF DESCRIPTION OF THE DRAWINGS

FIG. 1 is a cross-sectional view showing a furnace according to an exemplary embodiment of the present invention.

FIG. 2 is a top view of the furnace shown in FIG. 1.

FIG. 3 is a cross-sectional view showing a state in which a thermocouple is close to a fired matter.

FIG. 4 is a partially enlarged view of FIG. 1 according to a first exemplary embodiment of the present invention.

FIG. 5 is a partially enlarged view of FIG. 1 according to a second exemplary embodiment of the present invention.

FIG. 6 is a partially enlarged view of FIG. 1 according to a third exemplary embodiment of the present invention.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

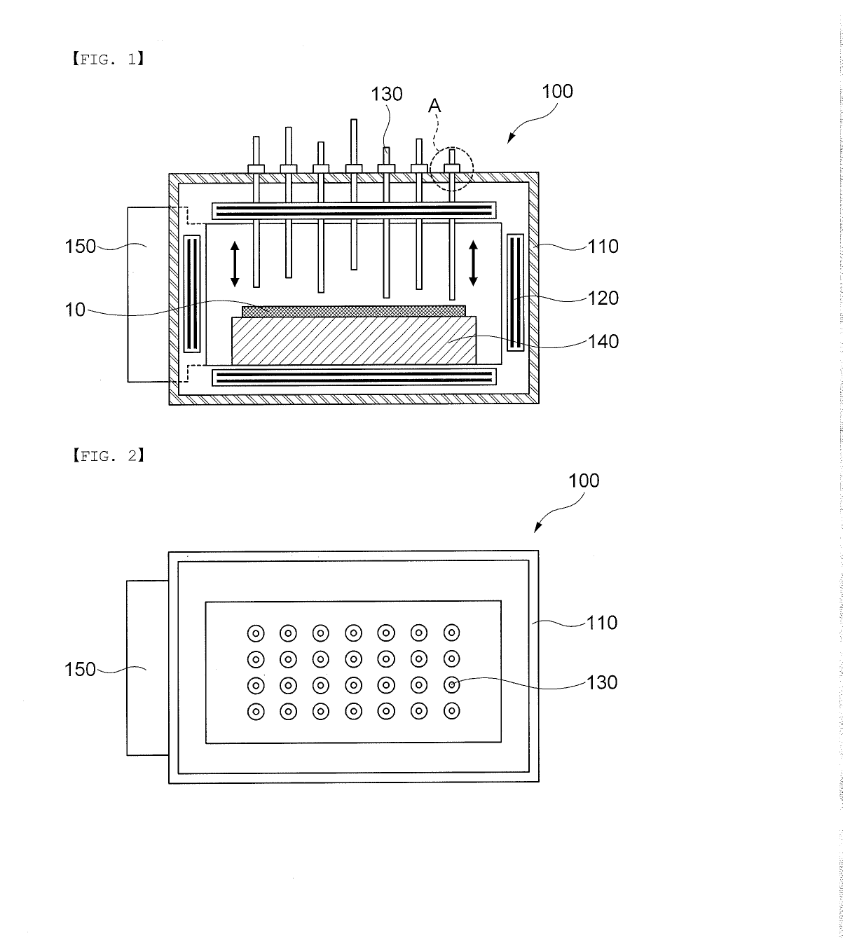

FIG. 1 is a cross-sectional view showing a furnace according to an exemplary embodiment of the present invention and FIG. 2 is a top view of the furnace shown in FIG. 1. Referring to FIGS. 1 and 2, a furnace 100 according to the exemplary embodiment of the present invention includes a body 110, a heating element 120, a thermocouple 130, and a control unit 150.

An inside of the body 110 is provided with a space and the space receives a fired matter 10. The fired matter 10 is supported by a firing setter 140.

An inner wall surface of the body 110 is provided with a heating element 120. The heat generated from the heating element 120 is transferred to the fired matter 10. The heating element 120 may be an electric heater, but the exemplary embodiment of the present invention is not limited thereto. As a result, various heating elements 120 that can emit heat may be used.

The thermocouple 130 is used to measure temperature in the body 110. The thermocouple 130 may measure a wide temperature range from 200° C. below zero to 1700° C. above zero within an error range of 0.1% to 1% and provide dynamic flexibility to change its own shape into an appropriate shape so as to adapt the used portions and as a result, has been widely used in temperature measurement fields.

The thermocouple 130 is coupled with the top surface of the body 110 so as to be able to vertically move. Therefore, when a height of the fired matter 10 is high, the thermocouple 130 rises and when the height of the fired matter 10 is low, the thermocouple 130 falls, such that the thermocouple 130 may be close to the fired matter 10 regardless of the height or the shape of the fired matter 10.

As described above, the exemplary embodiment of the present invention vertically moves the thermocouple 130 so as to be close to the fired matter 10, thereby measuring the actual temperature of the fired matter 10 rather than the temperature in the furnace 100.

Further, the thermocouple 130 may be disposed in plural. The exemplary embodiment of the present invention may use the plurality of thermocouples 130 to measure the temperature for each position in the body 110 and may detect the temperature distribution in the body 110 based on the measured temperature for each position. In addition, the plurality of thermocouples 130 are close to each of the portions of the fired matter 10, thereby measuring the temperature for each portion of the fired matter 10.

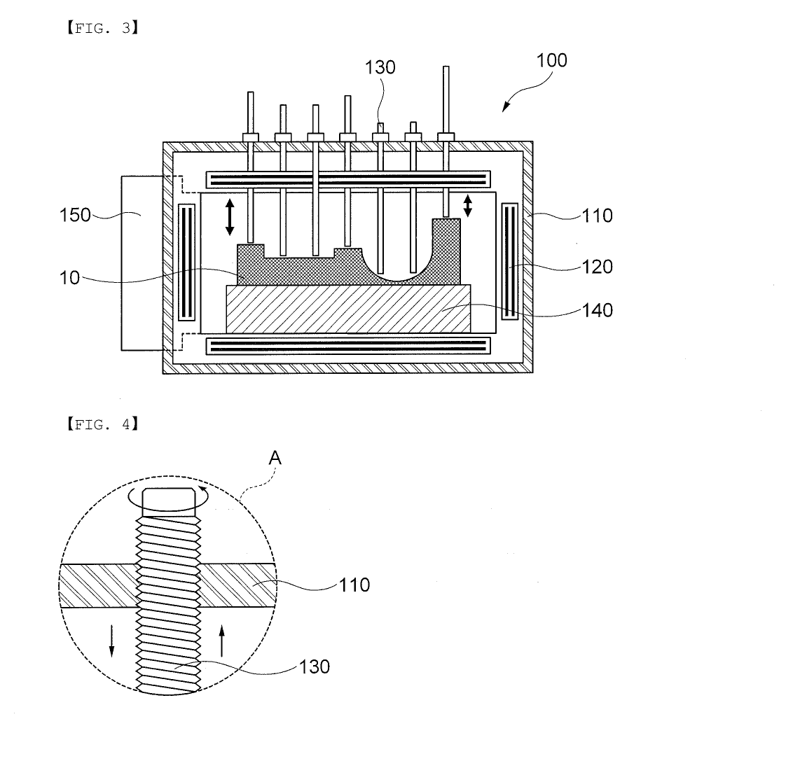

FIG. 3 shows a state in which the thermocouple 130 is close to the fired matter 10. As shown, the surface of the fired matter 10 shows a very irregular shape. It is impossible to measure the temperature for each portion of the fired matter 10. However, the exemplary embodiment of the present invention may measure the temperature for each portion through the configuration in which the plurality of thermocouples 130 are close to each surface of the fired matter 10.

In particular, when the fired matter 10 is a substrate having a cavity and a tapered form, the temperature may be measured by making the thermocouples 130 close to the surface of the fired matter as maximally as possible by separately moving the thermocouples according to the shape of the substrate.

As described above, the exemplary embodiment of the present invention may accurately measure the temperature for each portion regardless of the shape of the fired matter 10 to precisely control the temperature of the actual fired matter 10 and may control the sintered state of the cavity and tapered portions in the case of the substrate having the cavity and the tapered formed.

FIG. 2 shows 28 thermocouples 130, but the exemplary embodiment of the present invention is not limited thereto. As a result, when there is a need to more precisely measure the temperature distribution and the size of the furnace is large, more than 28 thermocouples 130 may also be used.

Further, the control unit 150 receives temperature data from the thermocouple 130 to control the temperature of the heating element 120. When there is a difference between the temperature received from the thermocouple 130 and the set firing temperature as a result of comparing them, the heating temperature of the heating element 120 is controlled to maintain the set firing temperature.

Meanwhile, the heating element 120 may be disposed in plural. This is to control the temperature for each portion in the furnace 100 by using several heating elements 120. For example, referring to FIG. 2, when the set firing temperature is 900° C. and the temperature measured in the thermocouple at the upper left is 895° C., the temperature of the heating element 120 at a position closest to the upper left rises to maintain the temperature at the upper end of 900° C.

In addition, when the temperature measured in the thermocouple 130 at the lower left is 950° C., the temperature of the heating element positioned at a portion closest to the lower left falls to maintain the temperature at the lower end of 900° C.

As described above, the furnace 100 according to the exemplary embodiment of the present invention measures and controls the temperature for each portion of the internal space to form uniform temperature distribution, in particular, makes the temperature distribution of heat applied to the fired matter 10 uniform to obtain the high-quality fired matter.

FIGS. 4 to 6 are partially enlarged views of portion A of FIG. 1. Hereinafter, a coupling structure of the body 110 and the thermocouple 130 will be described below with reference to FIGS. 4 to 6.

First, FIG. 4 shows a coupling relationship between the body 110 and the thermocouple 130 according to the first exemplary embodiment of the present invention. Referring to FIG. 4, the thermocouple 130 is screwed to the body 110.

A thread is formed along an outer peripheral surface of the thermocouple 130 and the body 110 is provided a thread corresponding thereto. By the configuration, when the thermocouple 130 rotates, the thermocouple 130 rises or falls according to the rotation direction. The coupling method can precisely control the height of the thermocouple 130, such that the thermocouple 130 may be close to the fired matter as maximally as possible.

The thermocouple 130 may rotate by a manual scheme that allows a user to directly rotate the thermocouple but still be automatically rotated by using a motor, or the like. Further, a sensor capable of measuring the height of the fired matter 10 is mounted in the body 110 and the thermocouple 130 may automatically move so as to be close to the fired matter 10.

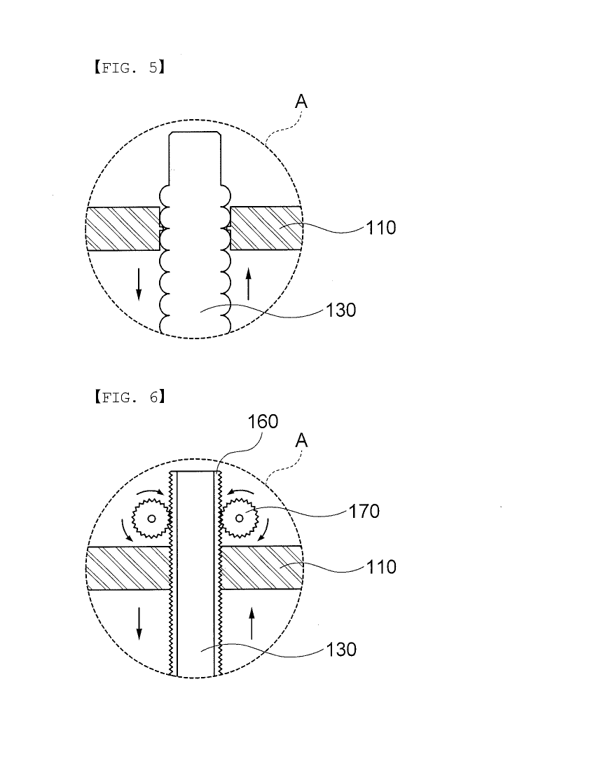

FIG. 5 shows a coupling relationship between the body 110 and the thermocouple 130 according to the second exemplary embodiment of the present invention. Referring to FIG. 5, the thermocouple 130 is fixed to the body 110 through a plurality of convex parts and a plurality of concave parts vertically formed.

The thermocouple 130 is vertically provided with the plurality of concave parts and the top surface of the body 110 are provided with the plurality of convex parts corresponding to the concave parts, such that the thermocouple 130 and the body 110 are fixed at a position at which the concave parts correspond to the convex parts, while the thermocouple 130 vertically moves.

Since the method of vertically moving the thermocouple 130 is very simple and intuitive, the coupling method may simplify an operation and rapidly change the position of the thermocouple 130 to shorten the firing working time.

The exemplary embodiment of the present invention describes that the thermocouple 130 is provided with the concave parts and the body 110 is provided with the convex parts. On the other hand, the thermocouple 130 is provided with the convex parts and the body 110 is provided with the concave parts, such that the thermocouple 130 and the body 110 may be coupled with each other.

FIG. 6 is a diagram showing the coupling relationship between the body 110 and the thermocouple 130 according to the third exemplary embodiment of the present invention. Referring to FIG. 6, the thermocouple 130 vertically moves by vertically fixing the thermocouple 130 to a rack gear 160 and rotating a pinion gear 170 corresponding to the rack gear 160.

The coupling method using the rack gear 160 and the pinion gear 170 does not need to perform further machining on the body 110 of the furnace 100, such that the body 110 may be made of a material that cannot be easily machined.

The pinion gear 170 may manually be rotated or automatically rotated by a motor, or the like. Further, similar to the first exemplary embodiment of the present invention, the inside of the body 110 is mounted with a sensor that can measure the height of the fired matter 10 and the thermocouple 130 may automatically move so as to be close to the fired matter 10.

Meanwhile, the body 110 may be a box type having a rectangular parallelepiped shape. The body 110 having the box type is appropriate for the case in which the fired matter 10 is a squared substrate, which may make the distribution of heat transferred to the squared substrate more uniform.

As set forth above, the furnace according to the exemplary embodiment of the present invention can measure and control the temperature for each portion of the internal space to provide uniform temperature distribution, in particular, make the temperature distribution of the heat applied to the fired matter uniform to obtain the high-quality fired matter.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A furnace, comprising:
a body having a space formed therein;
a plurality of thermocouples disposed in the body and vertically movably coupled with the body;
a plurality of heating elements disposed in the body; and
a control unit receiving temperature data from the thermocouples to control temperature of the heating elements.

2. The furnace according to claim 1, wherein the thermocouple is screwed to the body so as to vertically move by rotation.

3. The furnace according to claim 1, wherein the thermocouple and the body are fixed to each other through a plurality of convex parts and a plurality of concave parts that are vertically formed.

4. The furnace according to claim 1, further comprising a vertical rack gear fixed to the thermocouple and a pinion gear corresponding to the rack gear,
wherein the thermocouple vertically moves by the rotation of the pinion gear.

5. The furnace according to claims 1, wherein the body is a box type having a rectangular parallelepiped shape.
